(19) United States
(12) Patent Application Publication
(10) Pub. No.: US 2008/0146140 A1
(43) Pub. Date: Jun. 19, 2008

(54) Remote infection control device

(76) Inventor: Robert D. Harty, Mokena, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 11/584,249

(22) Filed: Oct. 20, 2006

(51) Int. Cl. B01L 1/04

(52) U.S. Cl. 454/187

(57) ABSTRACT

A device is provided for encapsulating a hand held electromagnetic radiation transceiver, the device comprising a hollow body having a top panel, a bottom panel, two side walls, and a front wall, said panels and walls continuously attached at their respective joints; a rear wall having an opening to allow insertion of the transceiver; whereby the device is finally hermetically sealed so as to prevent contamination of the transceiver by biological fluids, such as saliva, blood, and non-biological fluids, such as low-level radioactive waste, or organic materials. The device also contains indicators for pathogen and/or toxic agent contamination.

This Utility Patent Application claims the benefits of Provisional Application No. 60/728,235, filed on Oct. 19, 2005.

### BACKGROUND OF THE INVENTION

1. Field of the Invention

This invention relates to a device for prevention of transmission of infectious contaminants and, more specifically, the invention relates to a device for encapsulating, hand-held remote control units to prevent transmission of communicable illnesses and diseases.

2. Background of the Invention.

Bacteria and viruses thrive on a variety of surfaces and objects. Objects which can carry, and therefore facilitate transfer of these organisms are known as fomites.

One of the leading causes of the spread of bacterial and viral contamination within the home and within the hotel industry is the utilization of television remote control devices. These devices pass from hand to hand by numerous individuals. These individuals may both contaminate the remote control devices and become contaminated by the remote control devices. Remote control devices are ideal fomites for passing biological and non-biological contaminants from one person to another.

Devices exist related to imposing barriers between key pads and users. For example, U.S. Pat. No. 6,050,40, issued to Trujillo on Apr. 18, 2000 discloses a remote control cover. This device covers the key pad of a remote control unit, but not its ends. It is designed as an advertisement carrier, and as a protective film for the remote control unit.

Similarly, U.S. Pat. No. 6,705,787 B2, issued to Jeffries et al. on Mar. 16, 2004, protects the top of keyboards from spills and falling detritus such as crumbs, dirt, etc. However, the back of the keyboard is not similarly protected.

The above-described prior art protects the device from the user, but not vice-versa.

A secondary problem exists in hotel environments in which the television channel identification information is frequently unavailable to hotel guests. This unavailability is often due to missing channel information cards or the information sticker on the back of the remote control has become illegible due to extensive handling.

A need exists in the art for a device to stymie pathogen transfer via remote control units. The device should be disposable so as to afford change-out daily. The device also should embody a printable surface so as to facilitate channel information or advertisement messages. The device should also be readily adaptable to mobile phones, walkie-talkies, and other devices often used in emergency medical/fire/flood situations. The device would substantially hermetically seal or encapsulate the unit so as to prevent contamination and moisture invasion of the unit. The device would be water proof so as to facilitate washing/immersion in instances were a new encapsulation device is not readily available.

### SUMMARY OF INVENTION

An object of the present invention is to provide a remote control unit encapsulation device that overcomes many of the disadvantages of the prior art.

Another object of the present invention is to provide a device for substantially encapsulating a remote control unit. A feature of the device is the elimination of the possibility of direct contact between the unit and a user of the unit. An advantage of the device is that it prevents the unit from being contaminated by the user. Another advantage is that the device prevents the user from being contaminated by the unit.

Still another object of the present invention is to provide a washable capsule for containing a remote control unit. A feature of the invention is that the capsule allows the unit to be actuated and observed while simultaneously encapsulating the unit. An advantage of the invention is that the device is washable, thereby minimizing contamination between the users until a new capsule can be employed.

Yet another object of the present invention is to provide a printable, washable isolation capsule for a remote control device. A feature of the invention is that the capsule provides printed information on its surface while simultaneously isolating the device from contamination by biological and non-biological agents. An advantage of the device is that user identity information printed on the capsule combined with an analysis of contaminating agents on the capsule provides a user-contamination tracing mechanism.

Another object of the present invention is to provide a substrate which changes color over time and/or when exposed to predetermined pathogens, such as certain bacteria, chemicals, physiological fluids (such as blood, urine, semen, saliva, etc), plant toxins, animal-borne materials and the like. A feature of the substrate is that it is transparent. An advantage of the substrate is that it is molded or formed to encapsulate frequently handled tools or objects, while simultaneously allowing continued operation of the tools or objects.

Briefly, the invention provides a device for encapsulating a hand held electromagnetic radiation transceiver, the device comprising a hollow body having a top panel, a bottom panel, two side walls, and a front wall, said panels and walls continuously attached at their respective joints; a rear wall having an opening to allow insertion of the transceiver; and a means to hermetically seal said rear wall.

Also provided is a method for preventing contamination of a hand held tool, the method comprising providing an enclosure adapted to receive the tool, such that the enclosure allows for operation of the tool from outside the enclosure; contacting a bactericidal agent to an inside surface of the enclosure; inserting the tool inside said enclosure; and reversibly sealing the enclosure.

### BRIEF DESCRIPTION OF DRAWING

The invention together with the above and other objects and advantages of the present invention will be best understood from the following detailed description of the preferred embodiment of the invention shown in the accompanying drawing, wherein:

FIG. 1 depicts an elevational view of the device in accordance with the features of the present invention;

FIG. 2 is a view of the device, taken along line 2-2 of FIG. 1, in accordance with the features of the present invention;

FIGS. 3a-c depict exemplary detailed embodiments of the rear portion of the device, in accordance with the features of the present invention; and

FIG. 4 depicts an exemplary embodiment of the underside of the device, in accordance with the features of the present invention.

### DETAILED DESCRIPTION OF THE INVENTION

The invented device greatly reduces the chance of transfer of infectious agents from person to person via physical contact with remote control devices.

In the hotel setting, the invented device may be changed along with the linens to provide hotel guests with assurances of a relatively contamination-free remote control device upon check in.

The secondary benefit of the invented device is that television channel information may be silk-screened, screen printed, imprinted, or conveyed in some manner on the back of the device, thus ensuring such information is provided to hotel guests. Printing information on the invented device eliminates the need for information stickers on the remote controls themselves and the need for television information cards in the guest rooms.

Alternatively, directions for use of a remote control device for machines other than television sets may be printed on the back of the invented device. Exemplary machines include, but are not limited to, digital video display (DVD) players, radar guns, x-ray machines, and others.

### Device Detail

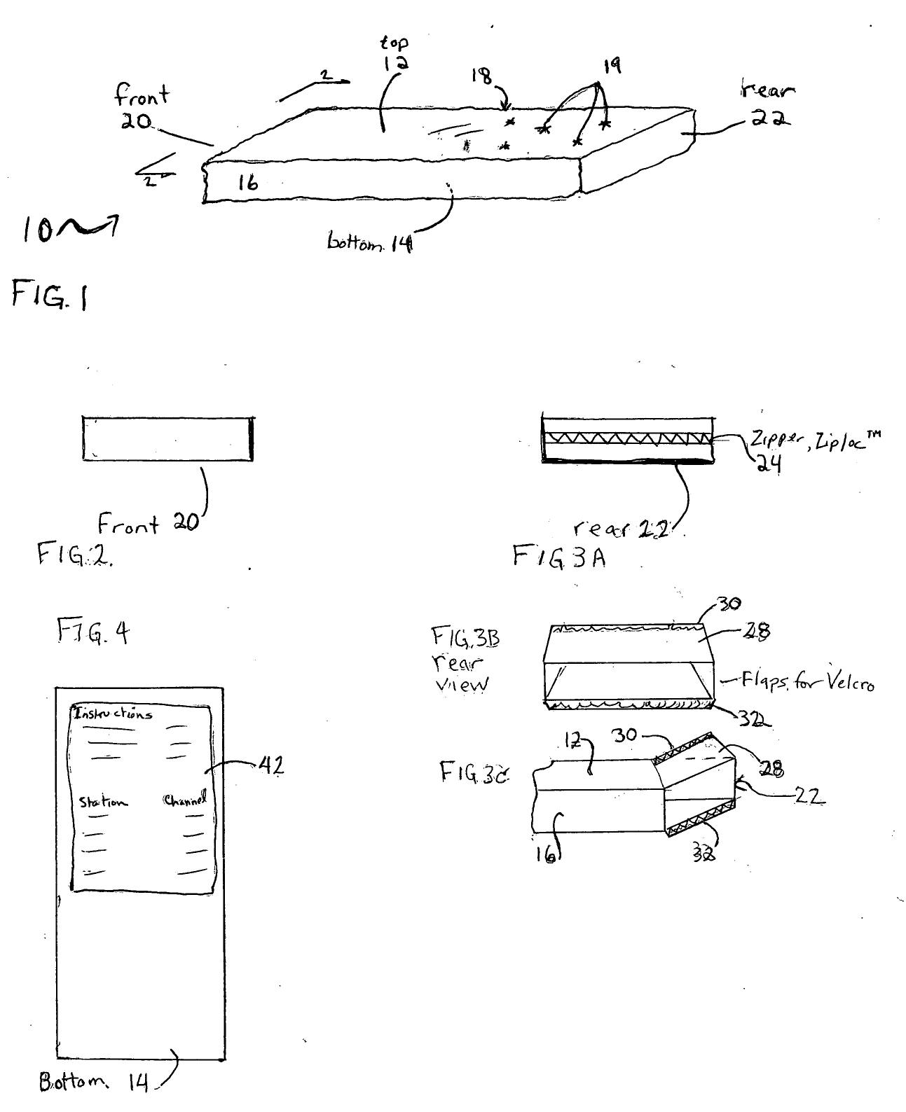

Several different embodiments and uses of the invention are described. One exemplary embodiment of the invented device is designated generally as numeral 10 in FIGS. 1-2.

Generally, the device 10 comprises a top panel 12, a bottom panel 14, two side walls 16 and 18, a front wall 20 and a rear wall 22 configured into a rectangular box-like enclosure. In one embodiment, the remote control unit is placed within a partially unfolded unit (the unfolded unit as depicted in FIGS. 3A and 3B) and sealed by heat weld or adhesive by the hotel/motel proprietor. In this embodiment, only hotel personnel have direct physical contact with the remote control unit.

Alternatively, the rear panel 22 of the device is integrally molded with a zip-loc or hook-and-pile configuration for reversible opening/closing functionality.

A primary feature of the device is in providing hermetic sealing to the remote control unit so as to minimize transfer of contaminants from the actual unit to the user and vice versa. For example, hermetic sealing assures that any hotel guest already infected with a cold or flu, for example, will not render the remote control unit a fomite.

### Construction Material Detail

Much of the device is constructed with nonmetallic material. Such material should allow for easy cleaning/sterilizing and also should not be prone to corrosion. Further, materials also can be selected to confer an acceptable level of radio-translucence. The incorporation of anti-static material into the construction of the device will further enhance its effectiveness and user-friendliness.

Typical materials for construction include, but are not limited to, a variety of types of plastic, and other types of material. The device can be designed and manufactured to allow for any size remote control unit to fit into the enclosure. The device has five sealed sides and one open side to allow for insertion and removal of the remote control. The open side of the device can be sealed with a Zip-loc™, zipper, snap, Velcro™, slide-rite™, hook and loop closure, adhesive, sewing thread, tape, flap lock, drawstring, or any other type of seal once the remote control has been inserted.

Aside from the reversibly removable function described in the immediately-preceding paragraph, the invented device can be constructed so that the remote control unit is placed in the device and heat sealed.

The device is relatively impermeable to polar substances such as water, and food, bodily fluids (such as blood and saliva) and semi-polar substances such as alcohol, ether and other solvents.

However, the impermeability characteristics of the device would not hinder transmission of electromagnetic radiation so that the functioning of the remote control unit would not be compromised. Also, radiation associated with walkie-talkie devices, mobile phones and Geiger-counter wands would be allowed to pass unhindered through the substrate comprising the device.

In another embodiment, the device is imprinted, screened, printed or in some manner with information or instructions to facilitate use of the remote control. Such information includes, but is not limited to, television channel guides, use instructions for performing operations of a machine by means of the remote control.

In an embodiment of the device, the device is comprised of a substrate which changes colors over time. This provides a visual cue of time expiration of effectiveness of the substrate prompting the user to replace or wash the device so as to minimize transfer of pathogens, adverse chemicals, or other types of toxins. Encapsulation of a tool or object by the substrate is such that complete immersion in water or some other cleaning solvent is facilitated. In this instance, the substrate provides a means for isolating the tool or encapsulated object from the cleaning fluid, thereby minimizing damage (such as electrical shorting to electrical componentry or spalling of the object's surface from chemical cleaners, etc) to the tool or object.

In addition to the time-induced color changing feature discussed supra, the color of the substrate changes over time upon the substrate's contamination with predetermined pathogens, including, but not limited to physiologically damaging radiation (e.g. gamma radiation), viruses, bacteria, and harmful agents found in blood, semen, urine, saliva, etc.

The instant embodiment incorporates commercially available methods for indicating bacteria presence through color change, including but not limited to the Bacteria Activity Reaction Test (aka BART) provided by LaMotte Company of Chestertown, Md. dealing with biofouling bacteria, and protocols provided in products by Puritec of Las Vegas, Nev. dealing with coliform bacteria.

Aside from the aforementioned “wet-chemistry” methods for color-indications of bacteria presence, solid-state devices are integrally molded into the invented pouch, including, but not limited to porous silicon optical microcavities as disclosed in J. Am. Chem. Soc. 123, 11797-11798 (2001); and Adv. Mater. 17, 2119-2203 (2005), both teachings of which are incorporated herein by reference. Such solid-state indicators are imbedded, sand-grain sized wafers (see element elements 19 in FIG. 1) that can differentiate between Gram-positive and Gram-negative bacteria and therefore accurately indicate the presence of salmonella, listeria, and enteropathogenic E. coli.

In light of the foregoing, any color change to the substrate encapsulating the tool provides a means to the user for indicating that the surface is contaminated, or that the tool is being exposed to contaminating material, or that the tool is no longer likely to be protected from continued use of the substrate.

Alternatively, the substrate is provided in conventional use-by-day color/number schemes such as those used in the food industry as follows:

| | | |
|---|---|---|
| 1. | Sunday | Black |
| 2. | Monday | Blue |
| 3. | Tuesday | Yellow |
| 4. | Wednesday | Red |
| 5. | Thursday | Brown |
| 6. | Friday | Green |
| 7. | Saturday | Orange |

While the invention has been described with reference to details of the illustrated embodiment, these details are not intended to limit the scope of the invention as defined in the appended claims. For example, to further stymie pathogen transport between remote control users and a remote control unit, a bactericidal agent can be applied to the invented encapsulation device, either to the interior of the device prior to insertion of the unit, or to the exterior of the device once a remote control unit is loaded and sealed within the device. Furthermore, the encapsulation device can be made of a material that is sterilizable, either chemically, or thermally, so as to be reused.

The embodiment of the invention in which an exclusive property or privilege is claimed is defined as follows:

1. A device for encapsulating a hand held electromagnetic radiation transceiver, the device comprising:
a. a hollow body having a top panel, a bottom panel, two side walls, and a front wall, said panels and walls continuously attached at their respective joints;
b. a rear wall having an opening to allow insertion of the transceiver; and
c. a means to hermetically seal said rear wall.

2. The device as recited in claim 1 wherein said hollow body is constructed from a flexible plastic material wherein said body flexibly yields to pressure.

3. The device as recited in claim 1 wherein said body is transparent to electromagnetic radiation.

4. The device as recited in claim 1 wherein said front wall contains a plurality of windows to facilitate passage of electromagnetic radiation.

5. The device as recited in claim 1 wherein said body prevents transmission of biological and non-biological contaminants.

6. The device as recited in claim 1 wherein said body prevents transmission of polar and semi-polar fluids.

7. The device as recited in claim 1 wherein said body prevents transmission of non-polar fluids.

8. The device as recited in claim 1 wherein the body displays a color, a number, or combinations thereof.

9. The device as recited in claim 8 wherein the color is selected based on when the body is applied to the transceiver.

10. The device as recited in claim 8 wherein the color is displayed after the body is contaminated.

11. The device as recited in claim 8 wherein the color is displayed after a predetermined time that the body is applied to the transceiver.

12. A method for preventing contamination of a hand held tool, the method comprising:
a) providing an enclosure adapted to receive the tool, such that the enclosure allows for operation of the tool from outside the enclosure;
b) contacting a bactericidal agent to an inside surface of the enclosure;
c) inserting the tool inside said enclosure; and
d) reversibly sealing the enclosure.

13. The method as recited in claim 12 wherein the enclosure is hermetically sealed from the environment.

14. The method as recited in claim 12 wherein a region of the inside surface is transparent to infra red radiation.

15. The device as recited in claim 12 wherein the body displays a color, a number, or combinations thereof.

16. The device as recited in claim 15 wherein the color is selected based on when the body is applied to the transceiver.

17. The device as recited in claim 15 wherein the color is displayed after the body is contaminated.

18. The device as recited in claim 15 wherein the color is displayed after a predetermined time that the body is applied to the transceiver.
